(19) United States
(12) Patent Application Publication
(10) Pub. No.: US 2021/0240556 A1
(43) Pub. Date: Aug. 5, 2021

(54) MACHINE-LEARNING DRIVEN COMMUNICATIONS USING APPLICATION PROGRAMMING INTERFACES

(71) Applicant: Optum Services (Ireland) Limited, Dublin (IE)

(72) Inventors: Conor Breen, Dublin (IE); Kirti Srivastava, Balgriffin (IE); Ciaran Mckenna, Dublin (IE); Kevin M. Larkin, Co Kildare (IE)

(21) Appl. No.: 16/782,122

(22) Filed: Feb. 5, 2020

(51) Int. Cl. G06F 9/54; G06N 20/00; G06N 5/04; G06Q 40/08; G06Q 20/02

(52) U.S. Cl. CPC G06F 9/547; G06N 20/00; G06Q 20/023; G06Q 40/08; G06N 5/04

(57) ABSTRACT

Methods, apparatus, systems, computing devices, computing entities, and/or the like for verifying the coordination of benefits information with an end-to-end automated process. First, one or more machine-learning models generate predictions for members who are likely to have insurance with another insurer. The members identified are processed through another one or more machine learning models that generate predictions for who the likely other insurers are. Each insurer is associated with an insurer record/profile that identifies one or more application programming interface templates. The API-based eligibility request templates can be automatically populated to generate eligibility API-based eligibility requests. And in turn, eligibility responses are received and used to update corresponding member profiles and process claims accordingly.

### BACKGROUND

The coordination of benefits occurs when a member of one health insurance company has additional coverage elsewhere. The additional coverage may be with another commercial health insurance company or with a government program (e.g., Medicare or Medicaid). The commercial coordination of benefits refers specifically to members who have health insurance with two separate health insurance companies. Coordination of benefits enables insurance companies to determine/identify primary insurers, avoid duplicate payments, and reduce the cost of insurance premiums for members. However, current approaches are manually driven and require human intervention to implement investigative processes. In addition to being dependent on manual processes, existing solutions are also dependent on the availability of precise member data, the ability to contact members and other insurers by telephone when verification of information is required and the quality of information held and shared by insurance companies.

Through applied effort, ingenuity, and innovation, the inventors have developed systems and methods that overcome the challenges of the manual-based approaches. Some examples of these solutions are described in detail herein.

### BRIEF SUMMARY

In general, embodiments of the present invention provide methods, apparatus, systems, computing devices, computing entities, and/or the like.

In accordance with one aspect, a method is provided. In one embodiment, the method comprises providing a first data set associated with a member as input to one or more first machine learning models, wherein (a) the one or more first machine learning models are configured to generate a predicted score indicating the likelihood of the member having additional insurance, and (b) the predicted score is generated based at least in part on the first data set; determining that the predicted score satisfies a configurable threshold; responsive to determining that the predicted score satisfies a configurable threshold, providing a second data set associated with the member as input to one or more second machine learning models, wherein (a) the one or more second machine learning models are configured to generate a predicted entity as the likely insurer providing the additional insurance, and (b) the predicted entity is generated based at least in part on the second data set; identifying an insurer profile data object for the predicted entity, wherein the insurer profile data object is associated with an API-based request template for electronically communicating with the entity through one or more APIs; and initiating the generation of an API-based request based at least in part on the API-based request template.

In accordance with another aspect, a computer program product is provided. The computer program product may comprise at least one computer-readable storage medium having computer-readable program code portions stored therein, the computer-readable program code portions comprising executable portions configured to provide a first data set associated with a member as input to one or more first machine learning models, wherein (a) the one or more first machine learning models are configured to generate a predicted score indicating the likelihood of the member having additional insurance, and (b) the predicted score is generated based at least in part on the first data set; determine that the predicted score satisfies a configurable threshold; responsive to determining that the predicted score satisfies a configurable threshold, provide a second data set associated with the member as input to one or more second machine learning models, wherein (a) the one or more second machine learning models are configured to generate a predicted entity as the likely insurer providing the additional insurance, and (b) the predicted entity is generated based at least in part on the second data set; identify an insurer profile data object for the predicted entity, wherein the insurer profile data object is associated with an API-based request template for electronically communicating with the entity through one or more APIs; and initiate the generation of an API-based request based at least in part on the API-based request template.

In accordance with yet another aspect, a computing system comprising at least one processor and at least one memory including computer program code is provided. In one embodiment, the at least one memory and the computer program code may be configured to, with the processor, cause the apparatus to provide a first data set associated with a member as input to one or more first machine learning models, wherein (a) the one or more first machine learning models are configured to generate a predicted score indicating the likelihood of the member having additional insurance, and (b) the predicted score is generated based at least in part on the first data set; determine that the predicted score satisfies a configurable threshold; responsive to determining that the predicted score satisfies a configurable threshold, provide a second data set associated with the member as input to one or more second machine learning models, wherein (a) the one or more second machine learning models are configured to generate a predicted entity as the likely insurer providing the additional insurance, and (b) the predicted entity is generated based at least in part on the second data set; identify an insurer profile data object for the predicted entity, wherein the insurer profile data object is associated with an API-based request template for electronically communicating with the entity through one or more APIs; and initiate the generation of an API-based request based at least in part on the API-based request template.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is a diagram of a prediction platform that can be used in conjunction with various embodiments of the present invention;

FIG. 2A is a schematic of an analytic computing entity in accordance with certain embodiments of the present invention;

FIG. 2B is a schematic representation of a memory media storing a plurality of repositories, databases, data stores, and/or relational tables;

FIG. 3 is a schematic of a clearinghouse computing entity in accordance with certain embodiments of the present invention;

FIG. 4A shows a first set of member features in accordance with certain embodiments of the present invention;

FIG. 4B shows a second set of member features in accordance with certain embodiments of the present invention;

FIGS. 5A and 5B are flowcharts for exemplary operations, steps, and processes in accordance with certain embodiments of the present invention;

FIGS. 6A and 6B are exemplary API-based eligibility requests in accordance with certain embodiments of the present invention; and

FIGS. 7A and 7B are exemplary API-based eligibility responses in accordance with certain embodiments of the present invention.

FIG. 8 is a dynamic coordination of benefits interface in accordance with certain embodiments of the present invention.

### DETAILED DESCRIPTION OF SOME EXAMPLE EMBODIMENTS

Various embodiments of the present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” (also designated as “/”) is used herein in both the alternative and conjunctive sense, unless otherwise indicated. The terms “illustrative” and “exemplary” are used to be examples with no indication of quality level. Like numbers refer to like elements throughout.

### I. Computer Program Products, Methods, and Computing Entities

Embodiments of the present invention may be implemented in various ways, including as computer program products that comprise articles of manufacture. Such computer program products may comprise one or more software components including, for example, software objects, methods, data structures, and/or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may comprise a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may comprise a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read-only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may comprise random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatus, systems, computing devices, computing entities, and/or the like. As such, embodiments of the present invention may take the form of a data structure, apparatus, system, computing device, computing entity, and/or the like executing instructions stored on a computer-readable storage medium to perform certain steps or operations. Thus, embodiments of the present invention may also take the form of an entirely hardware embodiment, an entirely computer program product embodiment, and/or an embodiment that comprises combination of computer program products and hardware performing certain steps or operations.

Embodiments of the present invention are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### II. Exemplary Platform Architecture

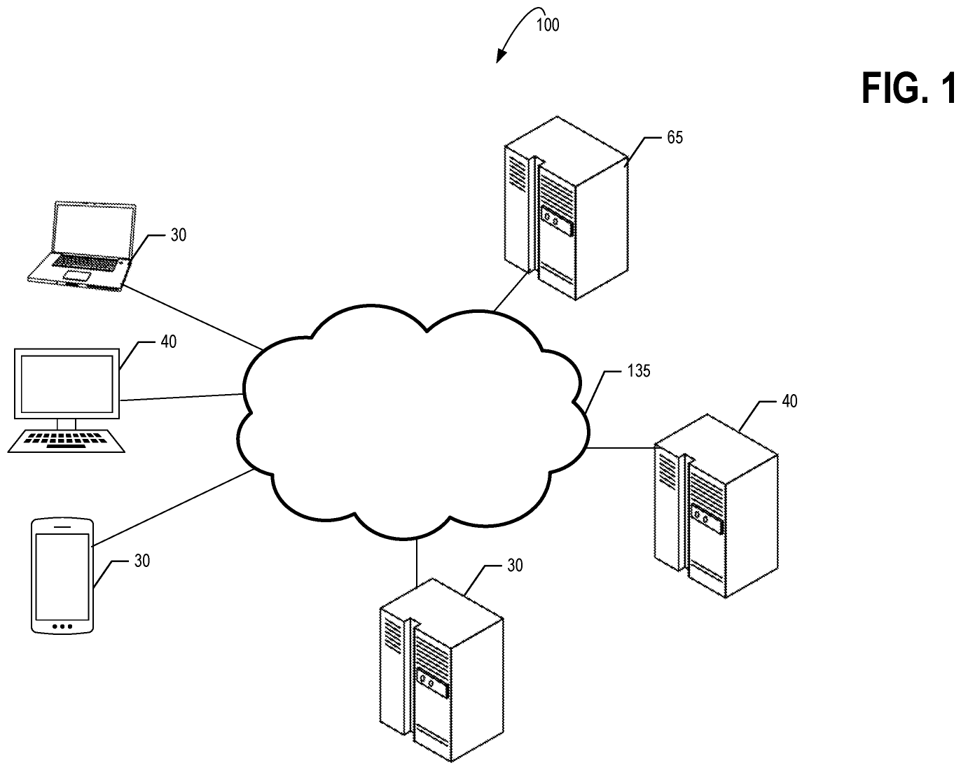

FIG. 1 provides an illustration of a prediction platform 100 that can be used in conjunction with various embodiments of the present invention. As shown in FIG. 1, the prediction platform 100 may comprise one or more analytic computing entities 65, one or more clearinghouse computing entities 30, one or more external computing entities 30, one or more networks 135, and/or the like. Each of the components of the platform may be in electronic communication with, for example, one another over the same or different wireless or wired networks 135 including, for example, a wired or wireless Personal Area Network (PAN), Local Area Network (LAN), Metropolitan Area Network (MAN), Wide Area Network (WAN), and/or the like. Additionally, while FIG. 1 illustrates certain platform entities as separate, standalone entities, the various embodiments are not limited to this particular architecture.

### Exemplary Analytic Computing Entity

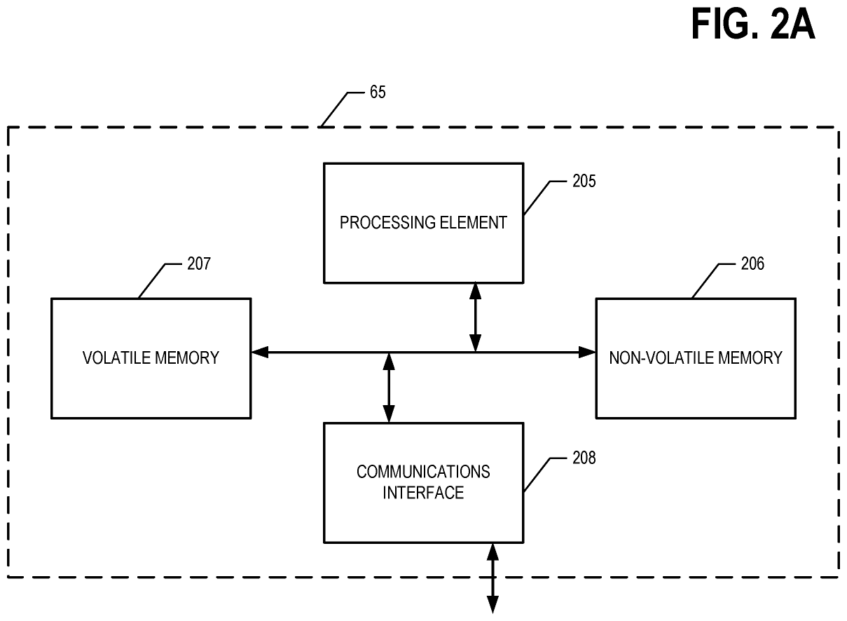

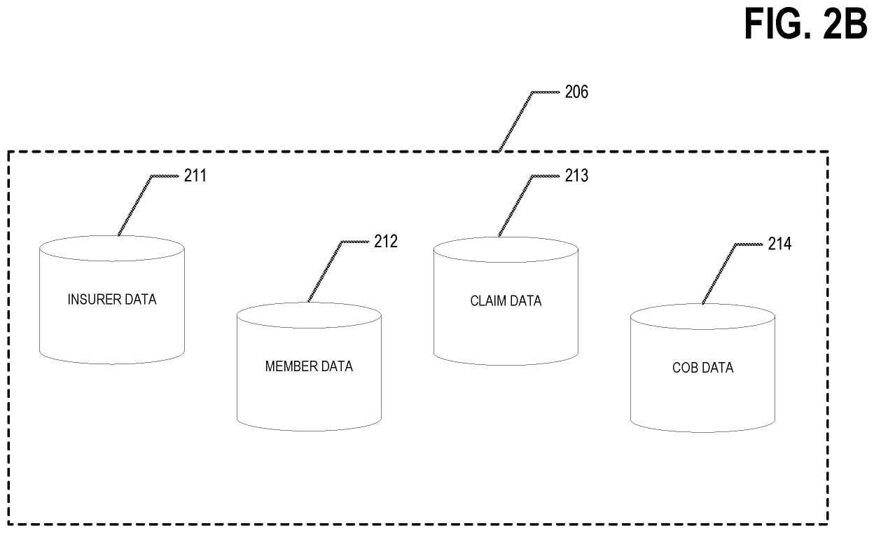

FIG. 2A provides a schematic of an analytic computing entity 65 according to one embodiment of the present invention. In general, the terms computing entity, entity, device, system, and/or similar words used herein interchangeably may refer to, for example, one or more computers, computing entities, desktop computers, mobile phones, tablets, phablets, notebooks, laptops, distributed systems, items/devices, terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may comprise, for example, transmitting/sending, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably. The analytic computing entity 65 may be a standalone entity or embedded as part of another platform, system, or entity.

As indicated, in one embodiment, the analytic computing entity 65 may also include one or more network and/or communications interfaces 208 for communicating with various computing entities, such as by communicating data, content, information, and/or similar terms used herein interchangeably that can be transmitted/sent, received, operated on, processed, displayed, stored, and/or the like. For instance, the analytic computing entity 65 may communicate with other computing entities 65, one or more external computing entities 30, and/or the like.

As shown in FIG. 2A, in one embodiment, the analytic computing entity 65 may comprise or be in communication with one or more processing elements 205 (also referred to as processors, processing circuitry, and/or similar terms used herein interchangeably) that communicate with other elements within the analytic computing entity 65 via a bus, for example, or network connection. As will be understood, the processing element 205 may be embodied in a number of different ways. For example, the processing element 205 may be embodied as one or more complex programmable logic devices (CPLDs), microprocessors, multi-core processors, coprocessing entities, application-specific instruction-set processors (ASIPs), and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present invention when configured accordingly.

In one embodiment, the analytic computing entity 65 may further include or be in communication with non-volatile media (also referred to as non-volatile storage, memory, memory storage, memory circuitry and/or similar terms used herein interchangeably). In one embodiment, the non-volatile storage or memory may comprise one or more non-volatile storage or memory media 206 as described above, such as hard disks, ROM, PROM, EPROM, EEPROM, flash memory, MMCs, SD memory cards, Memory Sticks, CBRAM, PRAM, FeRAM, RRAM, SONOS, racetrack memory, and/or the like. As will be recognized, the non-volatile storage or memory media may store databases, database instances, database management system entities, data, applications, programs, program modules, scripts, source code, object code, byte code, compiled code, interpreted code, machine code, executable instructions, and/or the like. The term database, database instance, database management system entity, and/or similar terms used herein interchangeably and in a general sense to refer to a structured or unstructured collection of information/data that is stored in a computer-readable storage medium.

Memory media 206 may also be embodied as a data storage device or devices, as a separate database server or servers, or as a combination of data storage devices and separate database servers. Further, in some embodiments, memory media 206 may be embodied as a distributed repository such that some of the stored information/data is stored centrally in a location within the system and other information/data is stored in one or more remote locations. Alternatively, in some embodiments, the distributed repository may be distributed over a plurality of remote storage locations only. An example of the embodiments contemplated herein would include a cloud data storage system maintained by a third party insurer and where some or all of the information/data required for the operation of the prediction platform may be stored. As a person of ordinary skill in the art would recognize, the information/data required for the operation of the prediction platform may also be partially stored in the cloud data storage system and partially stored in a locally maintained data storage system.

Memory media 206 may comprise information/data accessed and stored by the prediction platform to facilitate the operations of the system. More specifically, memory media 206 may encompass one or more data stores configured to store information/data usable in certain embodiments. For example, as shown in FIG. 2B, data stores encompassed within the memory media 206 may comprise insurer information/data 211, member information/data 212, claim information/data 213, coordination of benefit (COB) information/data 214, and/or the like.

As illustrated in FIG. 2B, the data stores 206 may comprise insurer information/data 211 with identifying/determining information/data indicative of one or more insurers. The term insurer is used generally to refer to any person or entity that provides, finances, reimbursees, and/or the like the cost of the services or products provided to members. For example, the insurer information/data 211 may comprise predicted confidence scores.

Continuing with FIG. 2B, the data stores 206 may comprise member information/data 212. The member information/data 212 may comprise information/data for a member, such as member records/profiles, age, gender, marital status, employment status, employment type, socioeconomic information/data (e.g., income information/data), poverty rates, relationship to the primary insured, insurance product information/data, insurance plan information/data, known health conditions, home location, profession, access to medical care, medical history, claim history, member identifier (ID), member classifications, language information/data, and/or the like.

Continuing with FIG. 2B, claim information/data may comprise claim information/data 213 indicative of claims filed on behalf of a provider for services or products. Examples of insurers include medical doctors, nurse practitioners, physician assistants, nurses, other medical professionals practicing in one or more of a plurality of medical specialties (e.g., psychiatry, pain management, anesthesiology, general surgery, emergency medicine, and/or the like), hospitals, urgent care centers, diagnostic laboratories, surgery centers, and/or the like. Moreover, the claim information/data 213 may further comprise prescription claim information/data. Prescription claim information/data may be used to extract information/data such as the identity of entities that prescribe certain drugs and the pharmacies who fulfill such prescriptions. The claim information/data 213 may also queue assignment information/data indicative regarding the queue to which the claim is assigned.

The data stores 206 may further store COB information/data 214 generated by the prediction platform. For example, the COB information/data 212 stored by the data store may identify other insurers for various members and/or the like.

In one embodiment, the analytic computing entity 65 may further include or be in communication with volatile media (also referred to as volatile storage, memory, memory storage, memory circuitry and/or similar terms used herein interchangeably). In one embodiment, the volatile storage or memory may also include one or more volatile storage or memory media 207 as described above, such as RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. As will be recognized, the volatile storage or memory media may be used to store at least portions of the databases, database instances, database management system entities, data, applications, programs, program modules, scripts, source code, object code, byte code, compiled code, interpreted code, machine code, executable instructions, and/or the like being executed by, for example, the processing element 308. Thus, the databases, database instances, database management system entities, data, applications, programs, program modules, scripts, source code, object code, byte code, compiled code, interpreted code, machine code, executable instructions, and/or the like may be used to control certain aspects of the operation of the analytic computing entity 65 with the assistance of the processing element 205 and operating system.

As indicated, in one embodiment, the analytic computing entity 65 may also include one or more network and/or communications interfaces 208 for communicating with various computing entities, such as by communicating data, content, information, and/or similar terms used herein interchangeably that can be transmitted/sent, received, operated on, processed, displayed, stored, and/or the like. For instance, the analytic computing entity 65 may communicate with computing entities or communication interfaces of other computing entities 65, external computing entities 30, and/or the like.

As indicated, in one embodiment, the analytic computing entity 65 may also include one or more network and/or communications interfaces 208 for communicating with various computing entities, such as by communicating data, content, information, and/or similar terms used herein interchangeably that can be transmitted/sent, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the analytic computing entity 65 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1×(1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. The analytic computing entity 65 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

As will be appreciated, one or more of the analytic computing entity's components may be located remotely from other analytic computing entity 65 components, such as in a distributed system. Furthermore, one or more of the components may be aggregated and additional components performing functions described herein may be included in the analytic computing entity 65. Thus, the analytic computing entity 65 can be adapted to accommodate a variety of needs and circumstances.

### Exemplary Clearinghouse Computing Entity 30

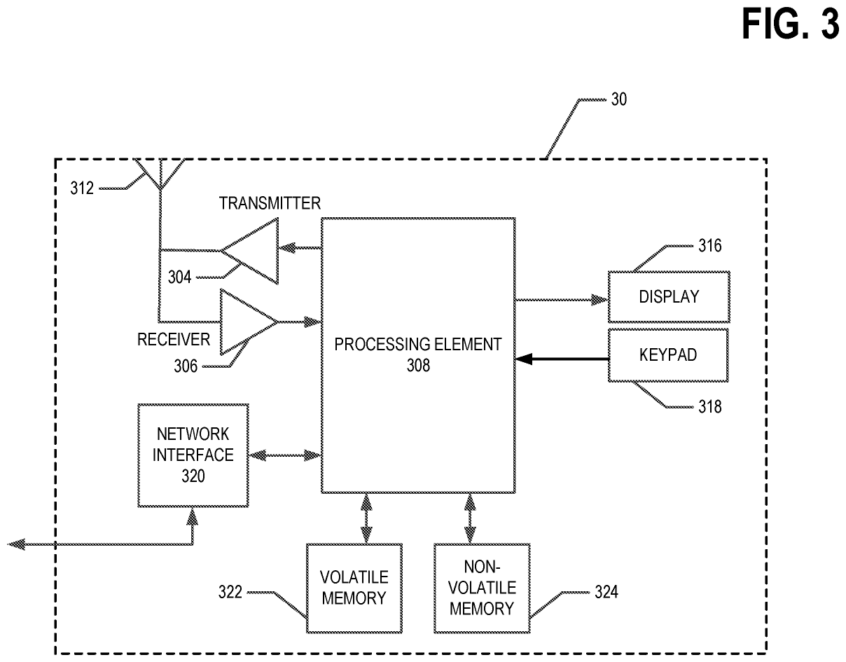

FIG. 3 provides an illustrative schematic representative of clearinghouse computing entity 30 that can be used in conjunction with embodiments of the present invention. As will be recognized, the clearinghouse computing entity 30 may be operated by a clearinghouse or an insurer and include components and features similar to those described in conjunction with the analytic computing entity 65. Further, as shown in FIG. 3, the clearinghouse computing entity 30 may comprise additional components and features. For example, the clearinghouse computing entity 30 can include an antenna 312, a transmitter 304 (e.g., radio), a receiver 306 (e.g., radio), and a processing element 308 that provides signals to and receives signals from the transmitter 304 and receiver 306, respectively. The signals provided to and received from the transmitter 304 and the receiver 306, respectively, may comprise signaling information/data in accordance with an air interface standard of applicable wireless systems to communicate with various entities, such as an analytic computing entity 65, another clearinghouse computing entity 30, and/or the like. In this regard, the clearinghouse computing entity 30 may be capable of operating with one or more air interface standards, communication protocols, modulation types, and access types. More particularly, the clearinghouse computing entity 30 may operate in accordance with any of a number of wireless communication standards and protocols. In a particular embodiment, the clearinghouse computing entity 30 may operate in accordance with multiple wireless communication standards and protocols, such as GPRS, UMTS, CDMA2000, 1×RTT, WCDMA, TD-SCDMA, LTE, E-UTRAN, EVDO, HSPA, HSDPA, Wi-Fi, WiMAX, UWB, IR protocols, Bluetooth protocols, USB protocols, and/or any other wireless protocol.

Via these communication standards and protocols, the clearinghouse computing entity 30 can communicate with various other entities using concepts such as Unstructured Supplementary Service data (US SD), Short Message Service (SMS), Multimedia Messaging Service (MMS), Dual-Tone Multi-Frequency Signaling (DTMF), and/or Subscriber Identity Module Dialer (SIM dialer). The clearinghouse computing entity 30 can also download changes, add-ons, and updates, for instance, to its firmware, software (e.g., including executable instructions, applications, program modules), and operating system.

According to one embodiment, the clearinghouse computing entity 30 may comprise location determining aspects, devices, modules, functionalities, and/or similar words used herein interchangeably. For example, the clearinghouse computing entity 30 may comprise outdoor positioning aspects, such as a location module adapted to acquire, for example, latitude, longitude, altitude, geocode, course, direction, heading, speed, UTC, date, and/or various other information/data. In one embodiment, the location module can acquire data, sometimes known as ephemeris data, by identifying/determining the number of satellites in view and the relative positions of those satellites. The satellites may be a variety of different satellites, including LEO satellite systems, DOD satellite systems, the European Union Galileo positioning systems, the Chinese Compass navigation systems, Indian Regional Navigational satellite systems, and/or the like. Alternatively, the location information/data may be determined by triangulating the position in connection with a variety of other systems, including cellular towers, Wi-Fi access points, and/or the like. Similarly, the clearinghouse computing entity 30 may comprise indoor positioning aspects, such as a location module adapted to acquire, for example, latitude, longitude, altitude, geocode, course, direction, heading, speed, time, date, and/or various other information/data. Some of the indoor aspects may use various position or location technologies including RFID tags, indoor beacons or transmitters, Wi-Fi access points, cellular towers, nearby computing devices (e.g., smartphones, laptops) and/or the like. For instance, such technologies may comprise iBeacons, Gimbal proximity beacons, BLE transmitters, Near Field Communication (NFC) transmitters, and/or the like. These indoor positioning aspects can be used in a variety of settings to determine the location of someone or something to within inches or centimeters.

The clearinghouse computing entity 30 may also comprise a user interface comprising one or more user input/output interfaces (e.g., a display 316 and/or speaker/speaker driver coupled to a processing element 308 and a touch screen, keyboard, mouse, and/or microphone coupled to a processing element 308). For example, the user output interface may be configured to provide an application, browser, user interface, dashboard, webpage, and/or similar words used herein interchangeably executing on and/or accessible via the clearinghouse computing entity 30 to cause display or audible presentation of information/data and for user interaction therewith via one or more user input interfaces. The user output interface may be updated dynamically from communication with the analytic computing entity 65. The user input interface can comprise any of a number of devices allowing the clearinghouse computing entity 30 to receive data, such as a keypad 318 (hard or soft), a touch display, voice/speech or motion interfaces, scanners, readers, or other input device. In embodiments including a keypad 318, the keypad 318 can include (or cause display of) the conventional numeric (0-9) and related keys (#, *), and other keys used for operating the clearinghouse computing entity 30 and may comprise a full set of alphabetic keys or set of keys that may be activated to provide a full set of alphanumeric keys. In addition to providing input, the user input interface can be used, for example, to activate or deactivate certain functions, such as screen savers and/or sleep modes. Through such inputs the clearinghouse computing entity 30 can collect information/data, user interaction/input, and/or the like.

The clearinghouse computing entity 30 can also include volatile storage or memory 322 and/or non-volatile storage or memory 324, which can be embedded and/or may be removable. For example, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management system entities, data, applications, programs, program modules, scripts, source code, object code, byte code, compiled code, interpreted code, machine code, executable instructions, and/or the like to implement the functions of the clearinghouse computing entity 30.

### Exemplary Insurer Computing Entity 40

As will be recognized, an insurer computing entity 40 may have similar components and functionality as the analytic computing entity 65 and/or the clearinghouse computing entity 30. For example, in one embodiment, each insurer computing entity 40 may include one or more processing elements (e.g., CPLDs, microprocessors, multi-core processors, cloud processors, coprocessing entities, ASIPs, microcontrollers, and/or controllers), one or more display device/input devices (e.g., including user interfaces), volatile and non-volatile storage or memory, and/or one or more communications interfaces. For example, the user interface may be a user application, browser, user interface, interface, and/or similar words used herein interchangeably executing on and/or accessible via the insurer computing entity 40 to interact with and/or cause display of information. This may also enable the insurer computing entity 40 to communicate with various other computing entities. As will be recognized, these architectures and descriptions are provided for exemplary purposes only and are not limiting to the various embodiments.

### Exemplary Networks

In one embodiment, the networks 135 may comprise, but are not limited to, any one or a combination of different types of suitable communications networks such as, for example, cable networks, public networks (e.g., the Internet), private networks (e.g., frame-relay networks), wireless networks, cellular networks, telephone networks (e.g., a public switched telephone network), or any other suitable private and/or public networks. Further, the networks 135 may have any suitable communication range associated therewith and may comprise, for example, global networks (e.g., the Internet), MANs, WANs, LANs, or PANs. In addition, the networks 135 may comprise any type of medium over which network traffic may be carried including, but not limited to coaxial cable, twisted-pair wire, optical fiber, a hybrid fiber coaxial (HFC) medium, microwave terrestrial transceivers, radio frequency communication mediums, satellite communication mediums, or any combination thereof, as well as a variety of network devices and computing platforms provided by network insurers or other entities.

### III. Exemplary System Operation

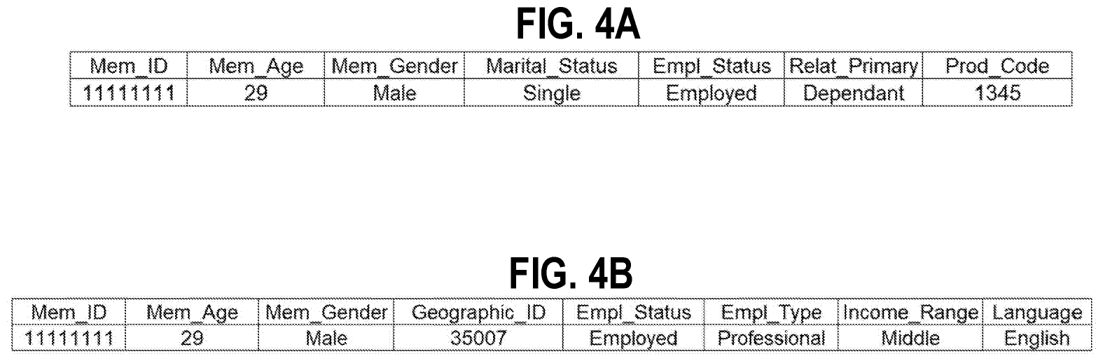

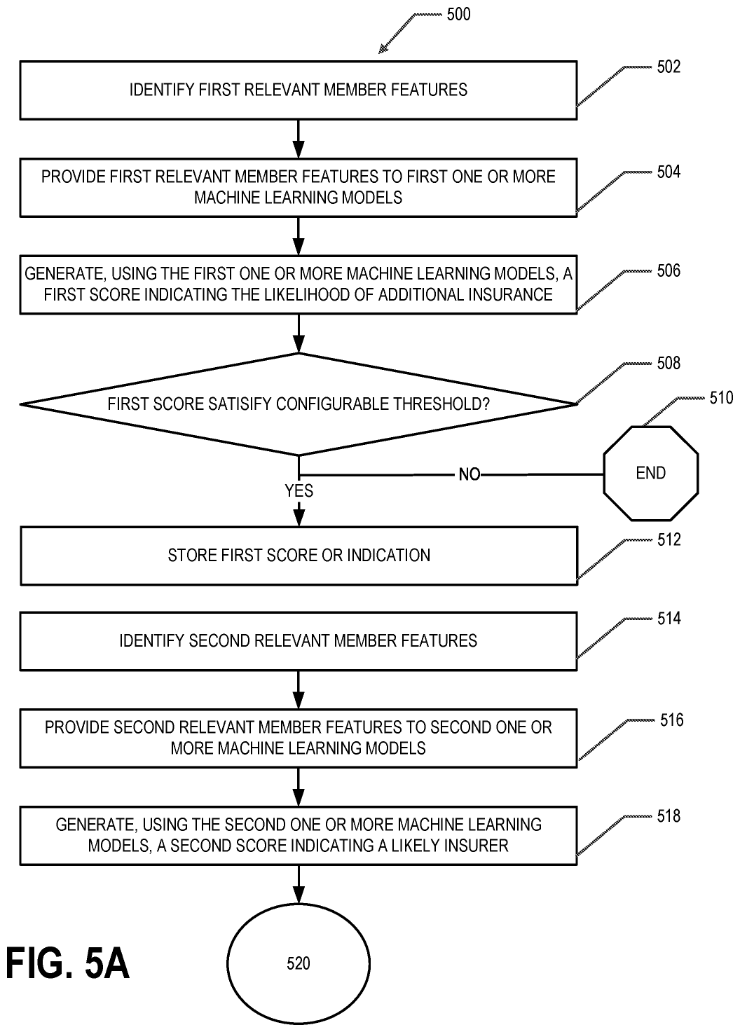

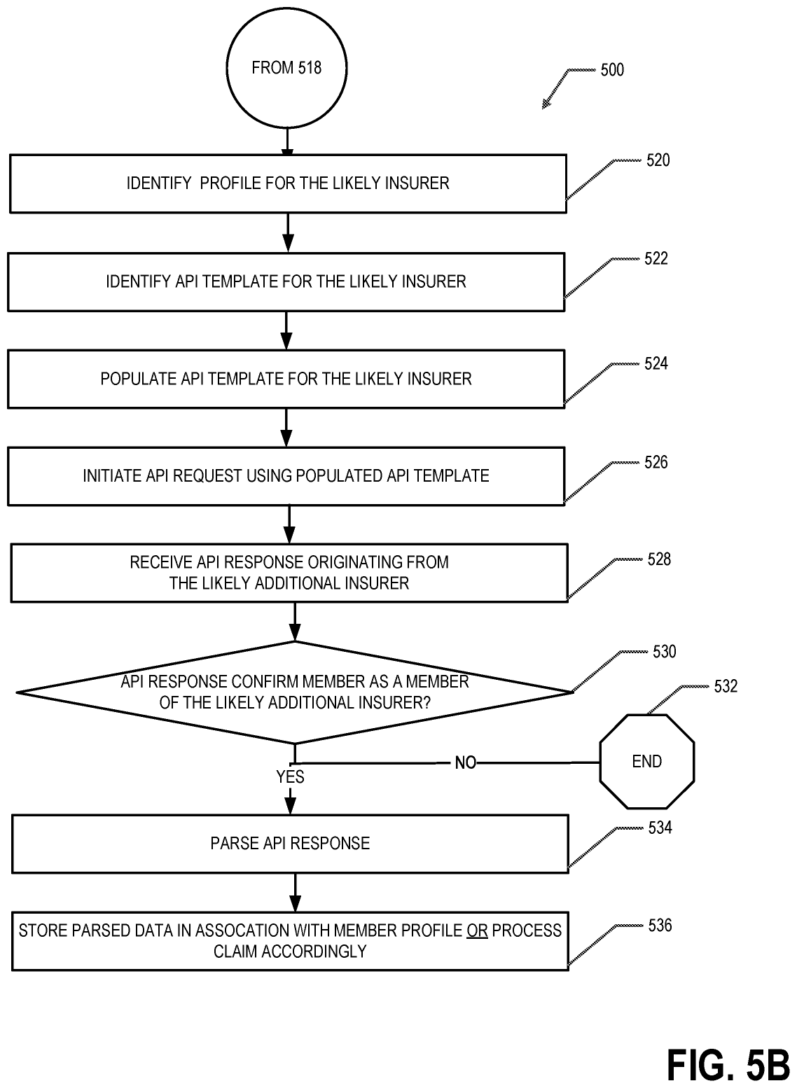

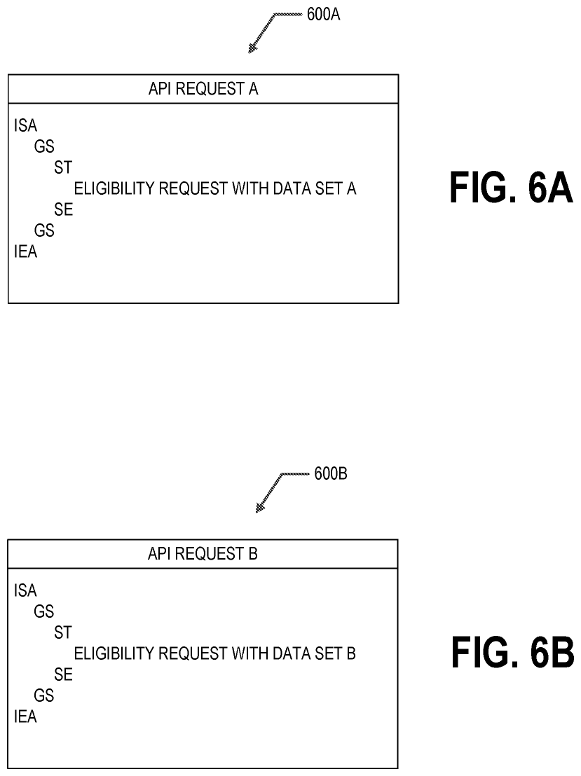

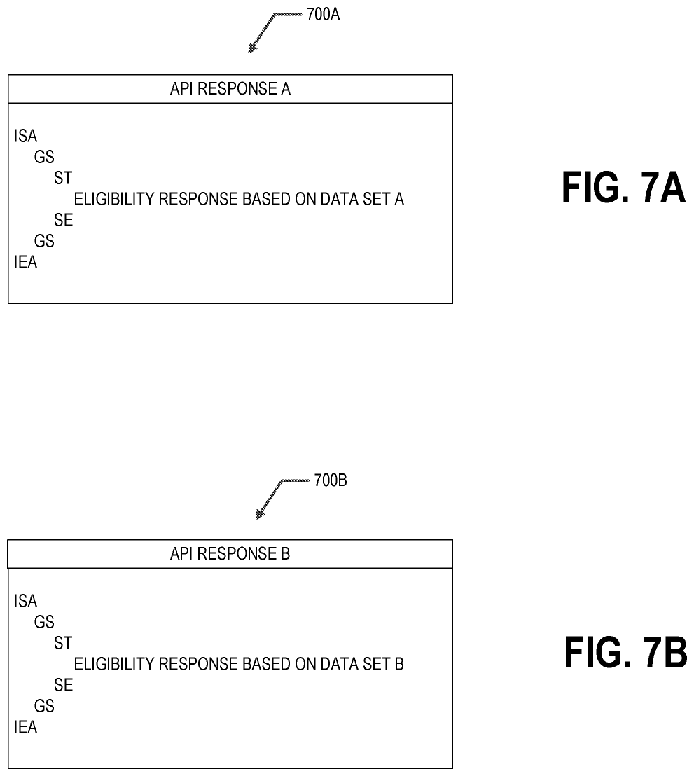

Reference will now be made to FIGS. 4A, 4B, 5A, 5B, 6, and 7. FIG. 4A shows a first set of member features. FIG. 4B shows a second set of member features. FIGS. 5A and 5B are flowcharts for exemplary operations, steps, and processes. FIG. 6 is an exemplary API-based eligibility request format. And FIG. 7 is an exemplary API-based eligibility response format.

### Brief Overview of Technical Problem

The coordination of benefits occurs when a member of one health insurance company has additional coverage elsewhere. The additional coverage may be with another commercial health insurance company or with a government program (e.g., Medicare or Medicaid). The commercial coordination of benefits refers specifically to members who have health insurance with two separate health insurance companies. Coordination of benefits enables insurance companies to determine/identify primary insurers, avoid duplicate payments, and reduce the cost of insurance premiums for members. However, current approaches are manually driven and require human intervention to implement investigative processes. In addition to being dependent on manual processes, existing solutions are also dependent on the availability of precise member data, the ability to contact members and other insurers by telephone when verification of information is required and/or the quality of information held and shared by insurance companies.

### Brief Overview of Technical Solution

Embodiments of the present invention provide concepts for replacing the existing manual processes of verifying the coordination of benefits information with an end-to-end automated process. First, one or more machine-learning models generate predictions for members who are likely to have insurance with another insurer. The members so identified are processed through another one or more machine learning models that generate predictions for who the likely other insurers are. Each insurer is associated with an insurer record/profile that identifies (e.g., identifies, is associated with, links to, corresponds to, and/or the like) one or more application programming interface (API) templates. The API-based eligibility request templates can be automatically populated for to generate eligibility API-based eligibility requests. And in turn, eligibility responses are received and used to update corresponding member profiles and process claims accordingly.

The disclosed solution is more effective, accurate, and faster than human investigation. Further, the machine learning models can carry out complex mathematical operations that cannot be performed by the human mind (e.g., determining a probability of other insurance for potentially millions of members). Additionally, by selectively using targeted API-based eligibility requests and corresponding responses, the use of network resources is minimized. For instance, if an API-based eligibility request and response were necessary for each member and potential insurer (75-100 insurers and/or more than 1,000 individual plans), the request and response traffic would inundate the network and require additional computational resources. Thus, this solution minimizes network work traffic, reduces the number of potential API-based eligibility requests and responses and thereby requires less computational resources for managing and handling the same.

### Member Records/Profiles

In one embodiment, a member record/profile may be a data object storing and/or providing access to member information/data 212. As noted previously, the term member may refer to a person who receives healthcare services or products rendered by a provider and/or who relies on financing from a health insurance insurer to cover the costs of the rendered health services or products. In that sense, a member may be associated with the health insurance insurer and may be considered a member (or member) of (a program associated with) the health insurance insurer. To do so, the prediction platform 100 may have and/or provide access to a member record/profile comprising information/data that has been previously established and/or stored. In an example embodiment, a member record/profile comprises member information/data 212, such as a member identifier configured to uniquely identify/determine the member (e.g., member identifier, user identifier, and/or the like), a username, user contact information/data (e.g., name (John Doe), one or more electronic addresses such as emails, instant message usernames, social media user name, and/or the like), member preferences, member account information/data, member credentials, information/data identifying/determining one or more member computing entities corresponding to the member, and/or the like. As noted, each member record/profile may correspond to a unique username, unique user identifier (e.g., 11111111), access credentials, and/or the like. With the member record/profile providing access to information/data through a user interface, the user can access and navigate the same. As will be recognized, a user may be a member, member representative, and/or the like.

In one embodiment, a member record/profile (stored by and/or accessible via one more databases) may also comprise member information/data 212, member features, and/or similar words used herein interchangeably that can be associated with a given member, claim, and/or the like. In one embodiment, member information/data 212 can include age, gender, poverty rates, known health conditions, home location, profession, access to medical care, medical history, claim history, member identifier, and/or the like. The member information/data 212 may also marital status, employment status, employment type, socioeconomic information/data (e.g., income information/data), relationship to the primary insured, insurance product information/data, insurance plan information/data, known health conditions, home location, profession, access to medical care, medical history, claim history, member identifier (ID), member classifications, language information/data, and/or the like. As will be recognized, the member information/data may comprise a variety of different types of information/data to adapt to various needs and circumstances.

### Insurer Records/Profiles

In one embodiment, an insurer record/profile (stored by and/or accessible via one more databases) may be a data object comprising insurer information/data, insurer features, and/or similar words used herein interchangeably that can be associated with a given insurer, claim, and/or the like. As indicated, an insurer may refer to an entity that provides, finances, reimbursees, and/or the like the cost of the services or products provided to members. In an example embodiment, an insurer record/profile may comprise insurer information/data 211, such as an insurer identifier configured to uniquely identify/determine the insurer, an insurance product identifier configured to uniquely identify/determine the insurance product, an insurance plan identifier configured to uniquely identify/determine the insurance plan, and/or the like. The insurer information/data 211 may comprise socioeconomic information/data associated with a particular insurer, product, or plan, insurance product information/data, insurance plan information/data, and/or the like.

Further, each profile may identify, be associated with, link to, and/or correspond to one or more API-based eligibility request templates that can be used for API-based requests and responses. The API-based eligibility request templates can be used to populate the member information/data and/or insurer information/data needed for a proper API-based eligibility request to comply with the requirements of a given insurer, insurance product, insurance plan, and/or the like. For instance, an API-based eligibility request template may comprise the root path for the version of the API, the authentication and other headers required in the API-based eligibility request, the path to call each endpoint, the methods available for use with each endpoint, available data fields and where each goes (e.g., path, query-string, or body), an explanation of what request data fields are required and what request data fields are optional, the status codes possible for each endpoint/method pairing, what each status code means in the context of each call, the data to expect in each response, including which responses will always be present, and/or the like.

### Process Initiation

The steps/operations of the disclosed processes can be initiated in a variety of ways. In one embodiment, the prediction platform 100 can systematically perform process 500 for each member on a regular, periodic, and/or continuous basis. In another embodiment, the prediction platform 100 can perform process 500 in response to one or more triggers. In a particular example, process 500 can be triggered when a healthcare claim (or any type of claim) is received. A claim represents a request for payment/reimbursement for services rendered, materials used, equipment provided, and/or the like. For example, a claim may be a request for payment/reimbursement for a consultation with a primary care doctor, a medical procedure or an evaluation performed by an orthopedic surgeon, a laboratory test performed by a laboratory, a surgery, durable medical equipment provided to an injured member, medications or other materials used in the treatment of a member, and/or the like. As will be recognized, though, embodiments of the present invention are not limited to the medical context. Rather, they may be applied to a variety of other settings—including a variety of other insurance contexts.

In one embodiment, each claim may be stored as a claim record or a claim data object that comprises a description of the type of claim to which the claim corresponds and comprises member features, claim features, insurer features, COB features, and/or the like. The various features and feature sets can be extracted in a manual, semi-automatic, and/or automatic manner for a given claim. As previously noted, the terms information, data, features, and other terms are used herein interchangeably. Example claim information/data may comprise a claim ID and the date and time the claim was received. The claim information/data may also include one or more diagnostic codes, treatment codes, treatment modifier codes, and/or the like. Such codes may be any code, such as Current Procedural Terminology (CPT) codes, billing codes, Healthcare Common Procedure Coding System (HCPCS) codes, ICD-10-CM Medical Diagnosis Codes, and/or the like.

As an example of billing codes, a member may visit a doctor because of discomfort in his lower leg. During the visit, the doctor may examine the member's lower leg and take an x-ray of the lower leg as part of an examination. The claim for the visit may have multiple distinct billing codes, such as billing code 99213 and billing code 73590. Billing code 99213 may be used to request payment/reimbursement for the visit, examination, and evaluation of the member. Billing code 73590 may be used to request payment/reimbursement for the x-ray of the leg. Using such codes and code sets, various correlations can be determined as they related to recoverability. Each claim may have a state and status. The states may be original, pre-adjudicated, or post-adjudicated. The three states relate to where the claim is in the process of being reviewed with a corresponding determination being made as to the claim's status. In addition to a state, a claim may also have a status: paid, denied, in process, appealed, appeal denied, overpaid, and/or the like.

From a process standpoint, once a claim is submitted, either through an online portal, through mail, through one or more APIs, and/or the like, the insurer initiates a programmatic review of the claim, which may trigger process 500. Once either the programmatic review of the claim and/or process 500 complete (which may also include a manual review), the claim is either rejected, modified, or paid in full.

### Generating Predictions for the Likelihood of Additional Insurance

Once process 500 has been initiated, the various steps/operations can be performed on a member-by-member basis. For example, at step/operation 502 of FIG. 5A, the analytic computing entity 65 can identify a first set of relevant member (e.g., user) features for input into one or more trained machine learning models. And depending on the prediction being generated, the importance of the first set of member features may vary. For instance, in a particular embodiment, the first set of member features may have weighted importance in determining whether a member is likely to have additional insurance. The following are non-limiting examples of potentially relevant member features for this prediction. As will be recognized, there member features may vary to adapt to different needs and circumstances.
Member biographic information/data.
Member relationship to the primary insured (dependents of the primary insured may be more likely to have additional insurance).
Member employment status (employed members may be more likely to have additional insurance).
Member marital status (married members may be more likely to have additional insurance).
Member age (younger members may be more likely to have additional insurance).
Insurer product or insurer product code (some insurer products may be more likely to have members with additional insurance).
Member geographic location (members in certain geographic locations may be more likely to have additional insurance).
Member claim history including diagnostic and procedure history

As indicated by step/operation 504 of FIG. 5A, the prediction platform 100 (e.g., via an analytic computing entity 65) can provide the first set of member features to one or more machine learning models. This may comprise formatting the first set of member features into a multidimensional vector for input into the one or more machine learning models. In a particular embodiment, the one or more machine learning models may be binary classification models. For example, the binary classification models can generate a prediction of whether or not a member is likely to have additional insurance (step/operation 506 of FIG. 5A). With binary classification models, the output of the one or more machine learning models (e.g., binary classification models) is a first predicted confidence score (e.g., a generated prediction). The first predicted confidence score indicates the machine learning model's (e.g., binary classification model's) predicted certainty of the corresponding member's likelihood of having additional insurance.

As will be recognized, to achieve these results, a variety of machine learning libraries and algorithms can be used to implement embodiments of the present invention. For example, gradient boosting with H2O, random forest, neural networks, decision trees, and/or various other machine learning techniques can be used to adapt to different needs and circumstances. In one embodiment, the machine learning models (e.g., binary classification models) may be pluggable machine learning models. A pluggable machine learning model can be downloaded and installed to make machine learning easier to use, extensible, and interchangeable.

As noted above, the output (e.g., the first predicted confidence score) of the one or more machine learning models for a given member is a first predicted confidence score. The first predicted confidence score may be within a variety of ranges. In a particular embodiment, the one or more machine learning models (e.g., binary classification models) can generate predictions in the range [0,1]. An exemplary output (e.g., a first predicted confidence score) for member John Doe corresponding to Member ID 11111111 is below.

TABLE 1
Member John Doe

Entity: 11111111
First Score: .73

With the output (e.g., the first predicted confidence score) from the one or more machine learning models, the prediction platform 100 (e.g., via an analytic computing entity 65) can determine whether the process should end at step/operation 510 of FIG. 5A or continue to step/operation 512 of FIG. 5A. To do so, at step/operation 508 of FIG. 5A, the prediction platform 100 (e.g., via an analytic computing entity 65) can determine whether the predicted confidence score (first predicted confidence score) satisfies a configurable threshold indicating that the member is likely to have additional insurance. Continuing with the above example, the configurable threshold may be 0.7 or 0.9. Moreover, the configurable threshold may be programmatically adjusted based at least in part on the communication costs and/or network costs for generating API-based eligibility requests and receiving API-based eligibility responses. In this embodiment, the threshold may be programmatically adjusted during peak times or off-peak times based at least in part on communication costs and network costs. In another embodiment, the configurable threshold may be adjusted based at least in part on the accuracy of the predictions. In such an embodiment, the threshold may be automatically adjusted through a feedback loop as responses are received at step/operation 530 of FIG. 5B. Further, the prediction platform 100 (e.g., via an analytic computing entity 65) can also generate a presentation for interaction with via user interface that shows the performance of the one or more machine learning models as a function of the configurable threshold. As will be recognized, a variety of different approaches and techniques can be used to adapt to various needs and circumstances.

At step/operation 508 of FIG. 5A, if the output (e.g., the first predicted confidence score) does not satisfy the configurable threshold, process 500 ends at step/operation 510 of FIG. 5A. Alternatively, at step/operation 508 of FIG. 5A, if the output (e.g., the first predicted confidence score) satisfies the configurable threshold, process 500 continues to step/operation 512 of FIG. 5A. At step/operation 512 of FIG. 5A, the prediction platform 100 (e.g., via an analytic computing entity 65) can store the output (e.g., the first predicted confidence score) in association with the member profile, in the COB data store, and/or the like.

### Generating Predictions of the Likely Additional Insurer

In one embodiment, step/operation 514 of FIG. 5A, the analytic computing entity 65 can identify a second set of relevant member (e.g., user) features for input into one or more trained machine learning models. And depending on the prediction being generated, the importance of the second set of member features may vary. For instance, in a particular embodiment, the second set of member features may have weighted importance in determining the identity of the likely additional insurer. The following are non-limiting examples of potentially relevant member features for this prediction. As will be recognized, there member features may vary to adapt to different needs and circumstances.
Member biographic information/data.
Market penetration of insurers in geographic area (e.g., country, province, state, city, town, postal code).
Geographic information/data.
Geographic socio-economic information/data.
Member socio-economic information/data.

As indicated by step/operation 516 of FIG. 5A, the prediction platform 100 (e.g., via an analytic computing entity 65) can provide the second set of member features to one or more machine learning models. This may comprise formatting the second set of member features into a multidimensional vector for input into the one or more machine learning models. In a particular embodiment, the one or more machine learning models may be multi-class classification models. For example, the multi-class classification models can generate a prediction as to the identity of the likely additional insurer (step/operation 518 of FIG. 5A). With multi-class classification models, the output of the one or more machine learning models (e.g., multi-class classification models) is an entity name (e.g., an insurer name, an insurance product, an insurance plan, and/or the like). The second predicted confidence score indicates the machine learning model's (e.g., binary classification model's) predicted certainty of the entity name (e.g., an insurer name, an insurance product, an insurance plan, and/or the like) being the additional insurer for the member.

As will be recognized, to achieve these results, a variety of machine learning libraries and algorithms can be used to implement embodiments of the present invention. For example, neural networks, Extreme Learning Machines (ELM), k-nearest neighbor, Naive Bayes, decision trees, support vector machines, and/or various other machine learning techniques can be used to adapt to different needs and circumstances. In one embodiment, the machine learning models (e.g., multi-class classification models) may be pluggable machine learning models.

As noted above, the output of the one or more machine learning models for a given member is an entity name and a second predicted confidence score. An exemplary output (e.g., a second predicted confidence score) for member John Doe corresponding to Member ID 11111111 is below.

TABLE 2
Member John Doe (Member ID 11111111

Entity: Short Term Medical Value of
Golden Rule Insurance Company
Second Score: .54

### Generating API-Based Requests and Responses

At step/operation 520 of FIG. 5B, with the output of the second one more machine learning models, the prediction platform 100 (e.g., via an analytic computing entity 65) can identify a profile for the corresponding insurer, insurance product, insurance plan, and/or the like. In one embodiment, the prediction platform 100 (e.g., via an analytic computing entity 65) may perform these steps for each output. In another embodiment, the prediction platform 100 (e.g., via an analytic computing entity 65) may only perform these steps for each output satisfying a second configurable threshold (such as that similar to the first configurable threshold). To identify a profile, the prediction platform 100 (e.g., via an analytic computing entity 65) can correlate the insurer, insurance product, insurance plan, and/or the like with a corresponding insurer ID (e.g., payer ID). The insurer ID (e.g., payer ID) can be used to identify a corresponding insurer record/profile that identifies one or more application programming API-based eligibility request templates (step/operation 522 of FIG. 5B). As previously noted, each profile may identify, be associated with, link to, correspond to, and/or the like one or more API-based eligibility request templates that can be used for API-based requests and responses. Each request template may be identifiable by a request template ID.

Further, each API-based eligibility request template may comprise various information/data. For example, an API-based eligibility request template may comprise the root path for the version of the API, the authentication and other headers required in the API-based eligibility request, and/or the path to call each endpoint, the methods available for use with each endpoint. The API-based eligibility request template may also comprise the available data fields and where each goes (e.g., path, query-string, or body) and/or an explanation of what request data fields are required and what request data fields are optional. For example, a given API-based eligibility request may range from having fifteen lines of text to having hundreds of lines of text based on the template. As an example, Insurer A might require a member ID for API-based eligibility request. See API-based eligibility request 600A in FIG. 6A. Similarly, Insurer B might not require a member ID, while requiring a date of birth. See API-based eligibility request 600B in FIG. 6B. Thus, a template for Insurer A may require a first data set, and a different template for Insurer B may require a second data set. The API-based eligibility templates may also include the status codes possible for each endpoint/method pairing, what each status code means in the context of each call, the data to expect in each response, including which responses will always be present, and/or the like.

In one embodiment, at step/operation 524 of FIG. 5B, the prediction platform 100 (e.g., via an analytic computing entity 65) can use the API-based eligibility request templates to populate the corresponding member information/data and/or insurer information/data needed for a proper API-based eligibility request to comply with the requirements of a given insurer, insurance product, insurance plan, and/or the like. And after populating the appropriate API-based eligibility request template with the corresponding member information/data and/or insurer information/data, the prediction platform 100 (e.g., via an analytic computing entity 65) can send/transmit the API-based eligibility request based at least in part on information/data associated with the template (step operation 526 of FIG. 5B). Responsive to sending/transmitting the API-based eligibility request, at step/operation 528 of FIG. 5B, the prediction platform 100 (e.g., via an analytic computing entity 65) can receive the API-based eligibility response originating from the insurer (e.g., communicating through an insurer computing entity 40).

In an alternative embodiment, the API-based eligibility requests are sent/transmitted by a clearinghouse computing entity. In such a case, the prediction platform 100 (e.g., via an analytic computing entity 65) can initiate the request by using the API-based eligibility request templates to populate (or provide to) the corresponding member information/data and/or insurer information/data for the clearinghouse computing entity (e.g., clearinghouse computing entity 30). The clearinghouse (e.g., via a clearinghouse computing entity 30) can send/transmit the API-based eligibility request based at least in part on information/data associated with the template. Responsive to sending/transmitting the API-based eligibility request, the clearinghouse (e.g., via a clearinghouse computing entity 30) can receive the API-based eligibility response originating from the insurer (e.g., communicating through an insurer computing entity 40).

In either embodiment, at step/operation 530, the prediction platform 100 (e.g., via an analytic computing entity 65) can determine whether the API-based eligibility response confirms that the member is a member of the insurer. In one embodiment, a positive API-based eligibility response is such a confirmation that the COB may be necessary. Similarly, a negative API-based eligibility response (e.g., a rejection) may confirm that the member is not a member of the insurer. Continuing with the above example, the API-based eligibility responses may comprise different data sets. For example, API-based eligibility response 700A of FIG. 7A may have different member information/data than API-based eligibility response 700B of FIG. 7B.

For negative responses, the process ends at step/operation 532 of FIG. 5B. For positive responses, the prediction platform 100 (e.g., via an analytic computing entity 65) continues to step/operation 534 of FIG. 5B. At step/operation 534 of FIG. 5B, the prediction platform 100 (e.g., via an analytic computing entity 65) parses positive API-based eligibility responses. In that regard, the prediction platform 100 (e.g., via an analytic computing entity 65) parses the positive API-based eligibility responses into discrete data fields that form the response. The parsed or extracted information/data from the positive API-based eligibility response may include member information/data and/or additional insurer information/data. Such member information/data and insurer information/data may comprise information/data (a) indicating the member being listed in a database of the additional insurer, (b) indicating that the member has active coverage with the additional insurer, (c) indicating the dates of coverage with the additional insurer, (d) indicating the level of coverage with the additional insurer (e.g., available benefits), (e) indicating the type of coverage with the additional insurer (e.g., government-based coverage or commercial coverage), and/or the like. At step/operation 536 of FIG. 5B, the prediction platform 100 (e.g., via an analytic computing entity 65) can store the parsed or extracted information/data (e.g., comprising member information/data and/or insure information/data) in association with the member profile, a claim data object, in the COB data store, and/or the like. In an embodiment in which a claim is being processed in real time, the prediction platform 100 (e.g., via an analytic computing entity 65) may approve the claim, deny the claim, or submit the claim for COB based at least in part on the same.

### Dynamically Update User Interface

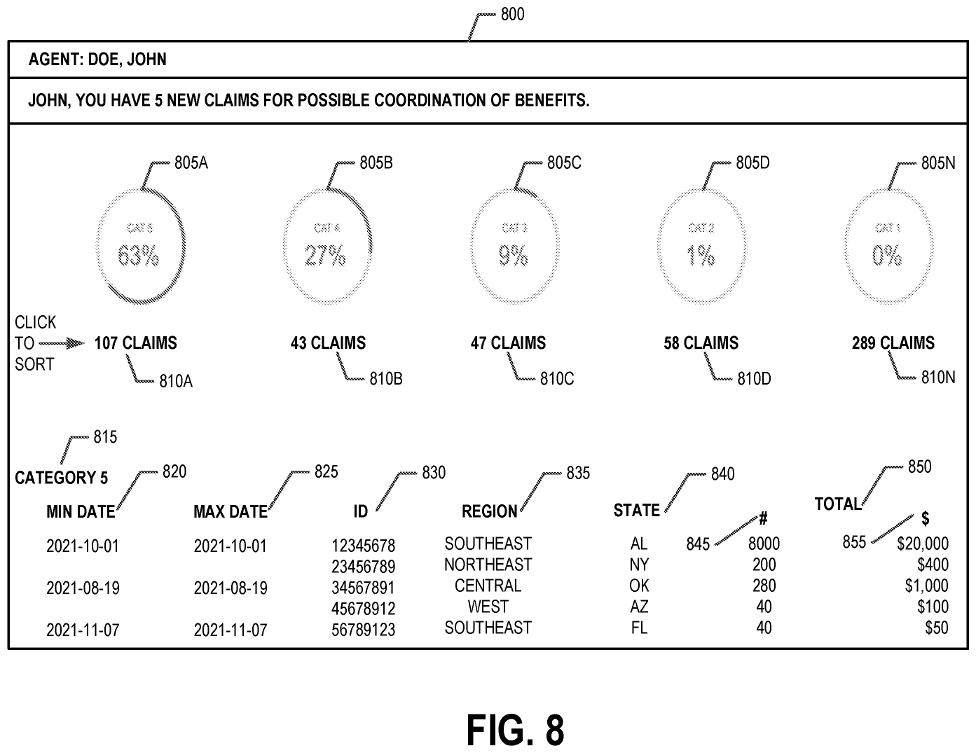

As will be recognized, in one embodiment, the above steps/operations can be implemented as a fully automated process without the user of a user interface. That is, with a positive API-based response, future claims can be coordinated without human intervention. In another embodiment, a user interface may be desirable. In such an embodiment, positive API-based responses may also be assigned to one or more review queues for accessing, viewing, investigating, and/or navigating via a user interface 800. As shown in FIG. 8, the user interface 800 can be dynamically updated to show the most current priority order of claims, for example, assigned to a user (e.g., COB agent) at any given time. For instance, if a claim in a queue is resolved and has a payment applied, the prediction platform 100 (e.g., via an analytic computing entity 65) can push an update to the corresponding queue and update the priority order of the queue. In another embodiment, the user interface 800 may dynamically update the queue being displayed on a continuous or regular basis or in response to certain triggers.

As shown via the user interface 800 of FIG. 8, the user interface may comprise various features and functionality for accessing, viewing, investigating, and/or navigating claims for possible COB opportunities. In one embodiment, the user interface 800 may identify the user (e.g., COB agent) credentialed for currently accessing the user interface 800 (e.g., John Doe). The user interface 800 may also comprise messages to the user in the form of banners, headers, notifications, and/or the like.

In one embodiment, the user interface 800 may display one or more claim category elements 805A-805N. The terms elements, indicators, graphics, icons, images, buttons, selectors, and/or the like are used herein interchangeably. In one embodiment, the claim category elements 805A-805N may represent respective queues assigned to a credentialed user. For example, claim category element 805A may represent a first queue assigned to a user, claim category element 805B may represent a second queue assigned to the user, and so on. In another embodiment, the claim category element 805A-805N may represent portions of a single queue assigned to the user based on COB threshold amounts. For example, the claim category element 805A may represent claims having an amount over or within a first amount threshold, the claim category element 805B may represent claims having an amount over or within a second amount threshold, and so on. In yet another embodiment, the claim category elements 805A-805N may comprise all of the claims in possible COB inventory and allow for reviewing the status of claims within particular thresholds. In one embodiment, each claim category element 805A-805N may be selected to control what the user interface 600 displays as the information/data in elements 615, 620, 625, 630, 635, 640, 645, 650, 655, and/or the like. For example, if claim category element 605A is selected via a user computing entity 30, elements 615, 620, 625, 630, 635, 640, 645, 650, and 655 are dynamically populated with information/data corresponding to category 5 claims.

In one embodiment, each claim category element 805A-805N may further be associated with category sort elements 810A-810N. The category sort elements 810A-810N may be selected via the user computing entity 30 to control how the user interface 800 sorts and displays the information/data in elements 815, 820, 825, 830, 835, 840, 845, 850, 855, and/or the like.

In one embodiment, elements 815, 820, 825, 830, 835, 840, 845, 850, 855, and/or the like may comprise claims (and at least a portion of their corresponding information/data) for a particular category. For example, element 815 may be selectable for sorting and represent the category of claims selected via a claim category element 805A-805N. Elements 820 and 825 may be selectable elements for sorting and represent minimum and maximum dates the claims were submitted, processed, and/or flagged for overpayment. Element 830 may be selectable for sorting and represent the ID of the claim, the ID of a provider who submitted the claim, the ID of a member to whom the claim corresponds, the ID of a possible additional insurer to whom the claim corresponds, and/or the like. Elements 835 and 840 may be selectable for sorting and represent location information for the corresponding claim line. And elements 845, 850, and 850 may be selectable for sorting and respectively represent potential COB amounts overpaid and/or the like of the claims being displayed. As will be recognized, the described elements are provided for illustrative purposes and are not to be construed as limiting the dynamically updatable user interface in any way. As will be recognized, these approaches and techniques can be adapted to a variety of needs and circumstances.

### VI. Conclusion

Many modifications and other embodiments of the inventions set forth herein will come to mind to one skilled in the art to which these inventions pertain having the benefit of the teachings presented in the foregoing descriptions and the associated drawings. For example, particular note is made that embodiments disclosed herein are applicable to any eligibility or multi-payer scenario (including automobiles claims and or the like) where there is a database or shared database where there is a need to identify likely members or those insured. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A computer-implemented method for automatically generating application programming interface (API) requests, the method comprising:
providing, by a platform comprising one or more processors, a first data set associated with a member as input to one or more first machine learning models, wherein (a) the member is an insured member of first insurer, (b) the one or more first machine learning models are configured to generate a first predicted score indicating the likelihood of the member having additional insurance with an additional insurer, (b) the first predicted score is generated based at least in part on the first data set, and (c) the platform is configured to execute one or more first machine learning models and one or more second machine learning models;
determining, by the platform comprising the one or more processors, that the first predicted score satisfies a configurable threshold, wherein satisfying the configurable threshold indicates that it is likely that the member has additional insurance with the additional insurer;
responsive to determining that the first predicted score satisfies the configurable threshold, providing, by the platform comprising the one or more processors, a second data set associated with the member as input to one or more second machine learning models, wherein (a) the one or more second machine learning models are configured to generate a second predicted score corresponding to a predicted entity as the additional insurer providing the additional insurance, and (b) the second score corresponding the predicted entity is generated based at least in part on the second data set;
identifying, by the platform comprising the one or more processors, an additional insurer profile data object for the predicted entity, wherein the additional insurer profile data object is associated with an API-based request template for electronically communicating with the predicted entity through one or more APIs; and
initiating, by the platform comprising the one or more processors, the generation of an API-based request based at least in part on the API-based request template.

2. The computer-implemented method of claim 1 further comprising:
generating, by the one or more processors, the API-based request based at least in part on the API-based request template; and
transmitting, by the one or more processors, the API-based request to an insurer computing entity.

3. The computer-implemented method of claim 1, wherein a clearinghouse computing entity:
generates the API-based request based at least in part on the API-based request template; and
transmits the API-based request to an insurer computing entity.

4. The computer-implemented method of claim 1 further comprising:
receiving, by the one or more processors, an API-based response originating from an insurer computing entity; and
determining, by the one or more processors, that the API-based response is positive.

5. The computer-implemented method of claim 4 further comprising:
responsive to determining that the API-based response is positive, parsing, by the one or more processors, the API-based response to extract an insurer entity data set; and
storing, by the one or more processors, the insurer entity data set in association with a member profile data object for the member.

6. The computer-implemented method of claim 1, wherein the first data set is provided as input to the one or more first machine learning models responsive receiving or generating a claim data object for the member.

7. The computer-implemented method of claim 1 further comprising:
dynamically updating, by the one or more processors, a user interface with at least a portion of the insurer entity data set.

8. A computer program product for automatically generating application programming interface (API) requests via a platform, the computer program product comprising a non-transitory computer readable medium having computer program instructions stored therein, the computer program instructions when executed by a processor, cause the processor to:
provide a first data set associated with a member as input to one or more first machine learning models, wherein (a) the member is an insured member of first insurer, (b) the one or more first machine learning models are configured to generate a first predicted score indicating the likelihood of the member having additional insurance with an additional insurer, (b) the first predicted score is generated based at least in part on the first data set, and (c) the platform is configured to execute one or more first machine learning models and one or more second machine learning models;
determine that the first predicted score satisfies a configurable threshold, wherein satisfying the configurable threshold indicates that it is likely that the member has additional insurance with the additional insurer;
responsive to determining that the first predicted score satisfies the configurable threshold, provide a second data set associated with the member as input to one or more second machine learning models, wherein (a) the one or more second machine learning models are configured to generate a second predicted score corresponding to a predicted entity as the additional insurer providing the additional insurance, and (b) the second score corresponding the predicted entity is generated based at least in part on the second data set;
identify an additional insurer profile data object for the predicted entity, wherein the additional insurer profile data object is associated with an API-based request template for electronically communicating with the predicted entity through one or more APIs; and
initiate the generation of an API-based request based at least in part on the API-based request template.

9. The computer program product of claim 8, wherein the computer program instructions when executed by a processor, further cause the processor to:
generate the API-based request based at least in part on the API-based request template; and
transmit the API-based request to an insurer computing entity.

10. The computer program product of claim 8, wherein a clearinghouse computing entity:
generates the API-based request based at least in part on the API-based request template; and
transmits the API-based request to an insurer computing entity.

11. The computer program product of claim 8, wherein the computer program instructions when executed by a processor, further cause the processor to:
receive an API-based response originating from an insurer computing entity; and
determine that the API-based response is positive.

12. The computer program product of claim 11, wherein the computer program instructions when executed by a processor, further cause the processor to:
responsive to determining that the API-based response is positive, parse the API-based response to extract an insurer entity data set; and
store the insurer entity data set in association with a member profile data object for the member.

13. The computer program product of claim 8, wherein the first data set is provided as input to the one or more first machine learning models responsive receiving or generating a claim data object for the member.

14. The computer program product of claim 8, wherein the computer program instructions when executed by a processor, further cause the processor to:
dynamically update a user interface with at least a portion of the insurer entity data set.

15. A platform for automatically generating application programming interface (API) requests, comprising a non-transitory computer readable storage medium and one or more processors, the computing system configured to:
provide a first data set associated with a member as input to one or more first machine learning models, wherein (a) the member is an insured member of first insurer, (b) the one or more first machine learning models are configured to generate a first predicted score indicating the likelihood of the member having additional insurance with an additional insurer, (b) the first predicted score is generated based at least in part on the first data set, and (c) the platform is configured to execute one or more first machine learning models and one or more second machine learning models;
determine that the first predicted score satisfies a configurable threshold, wherein satisfying the configurable threshold indicates that it is likely that the member has additional insurance with the additional insurer;
responsive to determining that the first predicted score satisfies the configurable threshold, provide a second data set associated with the member as input to one or more second machine learning models, wherein (a) the one or more second machine learning models are configured to generate a second predicted score corresponding to a predicted entity as the additional insurer providing the additional insurance, and (b) the second score corresponding the predicted entity is generated based at least in part on the second data set;
identify an additional insurer profile data object for the predicted entity, wherein the additional insurer profile data object is associated with an API-based request template for electronically communicating with the predicted entity through one or more APIs; and
initiate the generation of an API-based request based at least in part on the API-based request template.

16. The platform of claim 15, wherein the computing system is further configured to:
generate the API-based request based at least in part on the API-based request template; and
transmit the API-based request to an insurer computing entity.

17. The platform of claim 15, wherein a clearinghouse computing entity:
generates the API-based request based at least in part on the API-based request template; and
transmits the API-based request to an insurer computing entity.

18. The platform of claim 15, wherein the computing system is further configured to:
receive an API-based response originating from an insurer computing entity; and
determine that the API-based response is positive.

19. The platform of claim 18, wherein the computing system is further configured to:
responsive to determining that the API-based response is positive, parse the API-based response to extract an insurer entity data set; and
store the insurer entity data set in association with a member profile data object for the member.

20. The platform of claim 15, wherein the first data set is provided as input to the one or more first machine learning models responsive receiving or generating a claim data object for the member.

21. The platform of claim 15, wherein the computing system is further configured to:
dynamically update a user interface with at least a portion of the insurer entity data set.
